(19) United States
(12) Patent Application Publication
(10) Pub. No.: US 2014/0006318 A1
(43) Pub. Date: Jan. 2, 2014

(54) COLLECTING, DISCOVERING, AND/OR SHARING MEDIA OBJECTS

(71) Applicant: Poe XING, Pittsburgh, PA (US)

(72) Inventor: Poe XING, Pittsburgh, PA (US)

(21) Appl. No.: 13/538,477

(22) Filed: Jun. 29, 2012

(51) Int. Cl. G06F 3/01; G06F 15/16; G06F 15/18

(52) U.S. Cl. 706/12; 715/760

(57) ABSTRACT

A social media system provides for the collecting, discovering, and/or sharing of media objects among users. A user can collect an image, video clip, audio clip, text, graphics, and the like while browsing an internet resource or another suitable source. The collected media object can be used to discover other media objects that are relevant and/or similar to the collected media object. Relevance and/or similarity may be determined by one or more mechanisms for image classification. Collected images can be saved individually, or grouped together, e.g., as an album, for later retrieval. Collected images can also be shared with other users. The sharing may be based on a dynamic social graph with ad hoc nodes.

### BACKGROUND

1. Field

The present disclosure relates generally to social media applications, and more specifically to a social media application for collecting, searching, discovering, recommending, and/or sharing media objects.

2. Description of Related Art

Conventional web services for sharing media objects include internet web sites that allow users to collect media objects using technologies such as browser plug-ins and/or add-ons. These plug-ins and add-ons are cumbersome in that they may separate the user from the web browsing experience. For example, these technologies may display an intermediate web page for purposes of identifying and/or confirming the identity of a media object that is to be collected. Thus, the user must temporarily navigate away from the web page that was originally being viewed in order to collect a media object from the web page. These technologies are also cumbersome in that they may not provide a unified user interface for collecting media objects. For example, these technologies may require that a user navigate between providers of media objects in order to collect media objects from those providers based on the user interface of each individual provider.

Conventional web services for sharing media objects may not analyze a media object that has been collected by a user to identify other media objects that may be of interest to the user. For example, a user who has collected an image of a piece of modern furniture may be interested in seeing images of other modern furniture pieces, especially those collected by others in the user's social graph. However, conventional web services for sharing media objects may not perform searches for other relevant or similar media objects. Further, to the extent that conventional web services, such as search engines, provide image searching capabilities, their search capabilities are limited. For example, conventional web services may search for images based on only a text query, and retrieve images based on the text query. Text-driven image searches may be inaccurate because they do not leverage the visual content of images as a way of identifying search results. Further, many images present in the internet do not have textual meta-data associated with them, making them unsearchable by conventional, text-driven search technologies. Further still, to the extent that conventional web services provide search results, the search results may not be organized in a meaningful way.

### BRIEF SUMMARY

In some embodiments, a first media object is displayed on the screen of a mobile computing device, via an application that is native to the operating platform of the mobile computing device. The first media object is obtainable from a first source. A first classification and a second classification are identified for the first media object. The first classification and the second classification each represents at least a partial description of the first media object. The first classification and the second classification may be obtained using a machine learning mechanism. A plurality of media objects is obtained from a second source based on the first classification or the second classification. The plurality of media objects are displayed on screen, visually organized based on at least one of the first classification or the second classification.

In some embodiments, the level of classification of the first media object can be extended to a higher order, in a manner that is similar to the first and second classifications described above, in order to generate richer interpretations of the content of the first media object. The richer interpretations are used to enrich the display of the first media object and the plurality of media objects based on relatedness in the semantic meanings, styles, appearances, and/or moods of the media objects. The enrichment and discovery of the plurality of media objects can be performed via machine learning mechanisms.

In some embodiments, a first media object identifier is obtained from a user. The first media object identifier identifies a first media object obtainable from the internet. The location of the first user at the time when first media object identifier was obtained is identified as a first physical location. The first physical location and the media object identifier are sent to a server. A second user is identified based on the first physical location. The second user is identified because the second user was located within a particular distance of the first physical location at the time when the second media object was obtained. Information about the second user, and at least one second media object identified by the second user are displayed to the first user.

### DESCRIPTION OF THE FIGURES

FIG. 1 depicts a block diagram of an exemplary process for collecting, discovering, and sharing media objects.

FIG. 2 depicts an exemplary media object collection system.

FIG. 3 depicts an exemplary user interface for collecting a media object.

FIG. 4 depicts another exemplary user interface for collecting a media object.

FIG. 5 depicts another exemplary user interface for collecting a media object.

FIG. 6 depicts an exemplary user interface for discovering media objects.

FIG. 7 depicts another exemplary user interface for discovering media objects.

FIG. 8 depicts another exemplary user interface for collecting a media object.

FIG. 9 depicts another exemplary user interface for collecting a media object.

FIG. 10 depicts an exemplary user interface for identifying other users using an ad hoc social graph.

FIG. 11 depicts another exemplary user interface for collecting a media object.

FIG. 12 depicts an exemplary three-dimensional semantic space.

FIG. 13 depicts an exemplary coding matrix.

FIGS. 14A and 14B depict exemplary media objects.

FIG. 15 depicts a block diagram of an exemplary process for discovering media objects.

FIG. 16 depicts a block diagram of another exemplary process for discovering media objects.

FIG. 17 depicts another exemplary computing system for collecting, searching, discovering, recommending, and sharing media objects.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

The embodiments described herein include technologies directed to collecting, discovering, and/or sharing media objects in the social media. For example, a user can collect an image (which, as discussed below, is a type of media object) while browsing an internet web page. The collected image can be used to discover other relevant and/or similar images that are available via the internet or other suitable image sources. The user can also collect the newly discovered images. Collected images can be saved individually, or grouped together, e.g., as an album, for later retrieval. Collected images can also be shared with other users.

As used here, the term “media objects” refers to computer objects containing visual and/or aural information. Exemplary media objects include computer files that contain images, video clips, audio clips, text, graphics, and the like. Media objects can be collected from sources such as remote networked resources, local computing devices, and the like. Examples of remote networked resources of media objects include internet web sites and internet image databases. Examples of local computing devices that provide media objects include tablet computers, laptop computers, desktop computers, cellular phones, digital cameras, and the like. Examples of computing devices that may be used by a user to collect, discover, and/or share media objects include tablet computers, laptop computers, desktop computers, cellular phones, and the like.

In some embodiments, an application that is native to the operating platform of a tablet computer includes computer-executable instructions for collecting, discovering, and sharing media objects. For example, the native application may be an APPLE iOS “app” or a GOOGLE Android “application” or “widget” that provides a user interface.

### 1. Exemplary Process

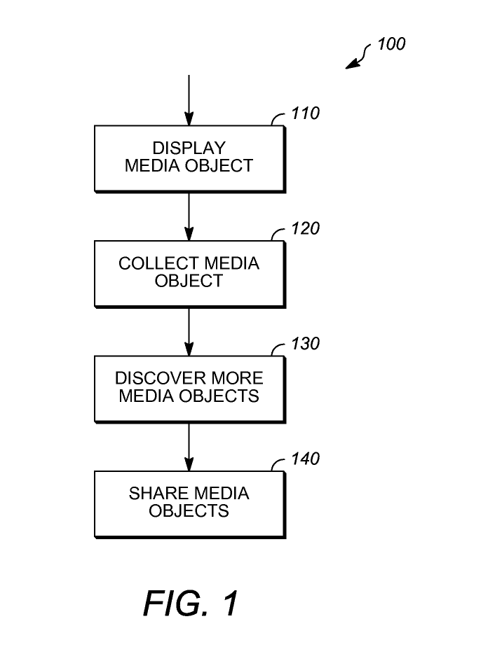

FIG. 1 illustrates exemplary process 100 for collecting, discovering, and sharing media objects. At block 110, a user accesses an information browser application that is native to the operating platform of a tablet computer, for example, or any other suitable computing device. The native application displays a web page that was obtained from a web server and that includes media objects in the form of text and images onto the display screen of the tablet computer.

At block 120, the user selects one of the displayed media objects (e.g., an image) for collection. The user may select the media object by tapping or clicking on the area of the screen where the media object is being displayed. Optionally, the user may classify the selected media object with category information. For purposes of illustration, exemplary categories include art, food, furniture, and so forth. A media object that is collected is stored at a media object collection server. A collected media object can become stored in at least two ways. For one, the tablet computer can transmit a copy of the media object to the media object collection server. The transmission may include meta-data information that is associated with the media object (e.g., the URL of a web page that references the media object). For another, the tablet computer can instruct the media object collection server to retrieve the media object directly from the web server that is hosting the media object.

Notably, the media object collection process does not require that the user navigate to another web page, such as an intermediate page or a pop-up window, for purposes of selecting, annotating, and/or confirming the media object that is to be collected. That is, the collection process need not remove a user from the original browsing experience. Further, the collection process does not require that a “plug-in” application program be installed for use in conjunction with the native application that is operating on the tablet computer. Rather, the native application that causes the media object to be displayed can also be the application that causes the media object to be collected.

At block 130, the local computing device discovers and displays (i.e., recommends) other media objects that are relevant to and/or similar to the collected media object. As used here, similarity refers to similarity in the technical contents among media objects, and is distinguishable from the use of the same term, for example, by text-based image search engines to describe correspondence between a text-based search string and text-based image tags. Further, relevance refers to relatedness in semantic meaning, style, appearance, mood, etc., among media objects. For example, a media object containing a bird's-eye view of the Statue of Liberty and a media object containing a front view of the Statue of Liberty would have common semantic meaning (i.e., both are images of the same statue), but would look vastly different. These two images can be described as being relevant but not similar to each other. Further, a media object containing an image of the Mona Lisa painting would be related to other works of art by Leonardo da Vinci, but would not necessarily be similar to those other works of art.

The discovery of relevant and/or similar media objects can be performed by the tablet computer and/or by a media object collection server that is working in conjunction with the tablet computer. The discovery of other media objects is based on machine learning mechanisms, including those described below. Machine learning mechanisms that are used are capable of searching for a type of media objects based on the semantic meaning and/or the visual content of a query object of the same type. That is, the machine learning mechanisms can search for images using other images, and need not rely on text-based tags.

At block 140, collected media objects may be shared with other users. The sharing of media objects may be based on a social graph of the user who has collected the media objects. The social graph may be maintained by a third-party social media website (e.g., FACEBOOK). The social graph may also be maintained by the native application and/or by a media object collection server. The social graph may be augmented dynamically with ad hoc nodes, meaning that nodes that are not within an existing social graph can be identified using the physical location (e.g., GPS location) of users and/or the timing of when media objects are being collected. For example, users who are within a certain distance of each other and/or who have collected media objects within a certain time period may be allowed to view the media objects that were collected by each other, as if the users are connected on an existing social graph. Once identified, an ad hoc node can be incorporated into an existing social graph. In this way, users who are related geographically and/or temporally by their media object collection activities (who are thus likely to have similar interests) can keep track of the future media object collection activities of one another.

### 2. Exemplary System

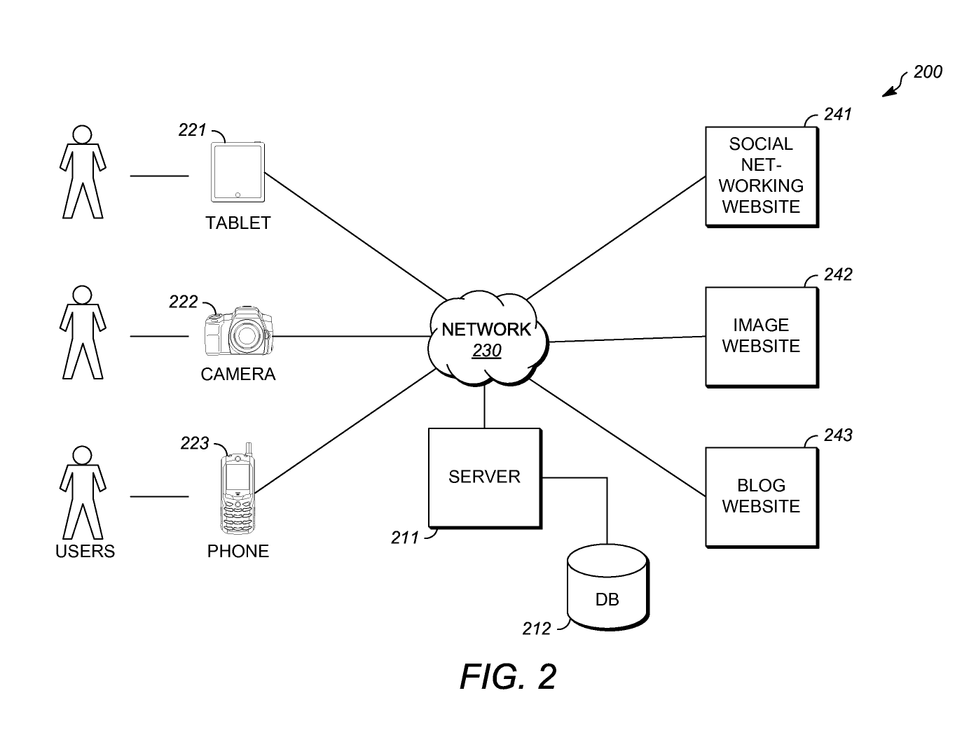

FIG. 2 illustrates an exemplary system 200 that supports the collecting, searching, discovering, recommending, and/or sharing media of objects. Exemplary system 200 includes media object collection server 211 and database 212. Media object collection server 211 includes computer instructions for communicating with computing devices to collect, discover, and/or share media objects. Database 212 stores media objects. Media object collection server 211 communicates with computing devices 221-223 over network 230. Computing device 221 is a tablet computer. Computing device 222 is a camera. Computing device 223 is a cellular phone. Media object collection server 211 and computing devices 221-223 communicate with information service providers 241-243. Information service provider 241 may be an internet social networking website, such as FACEBOOK. Information service provider 242 may be an internet image database, such as IMAGENET. Information service provider 243 may be an internet image blog, such as FLICKR.

### 3. Exemplary User Interface

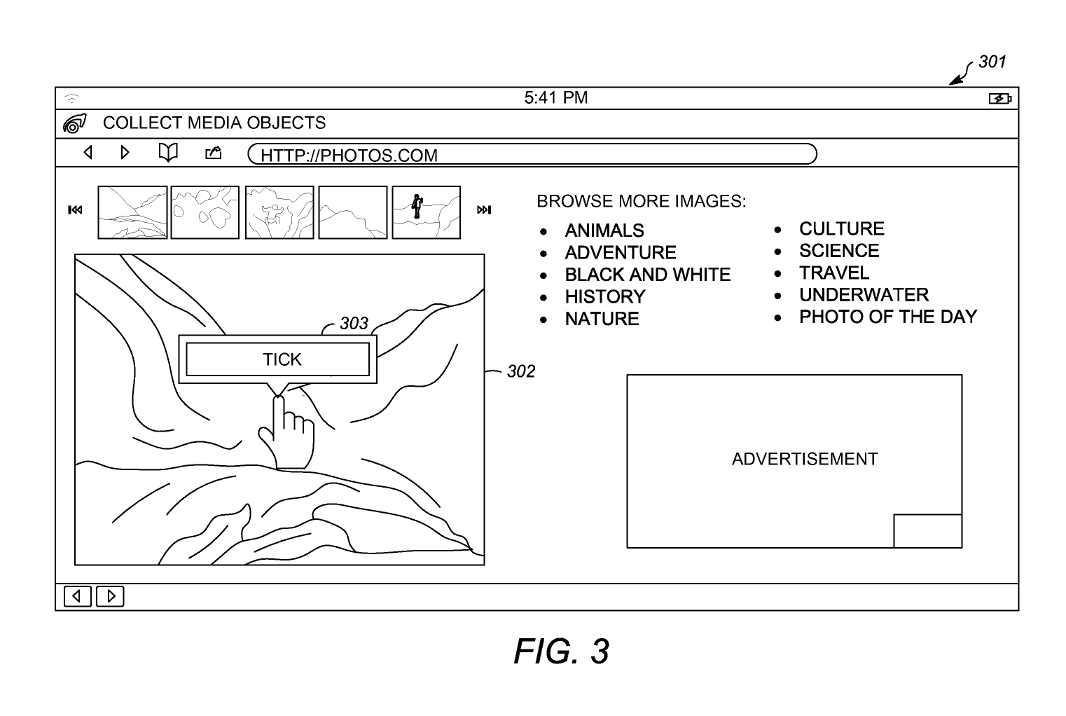

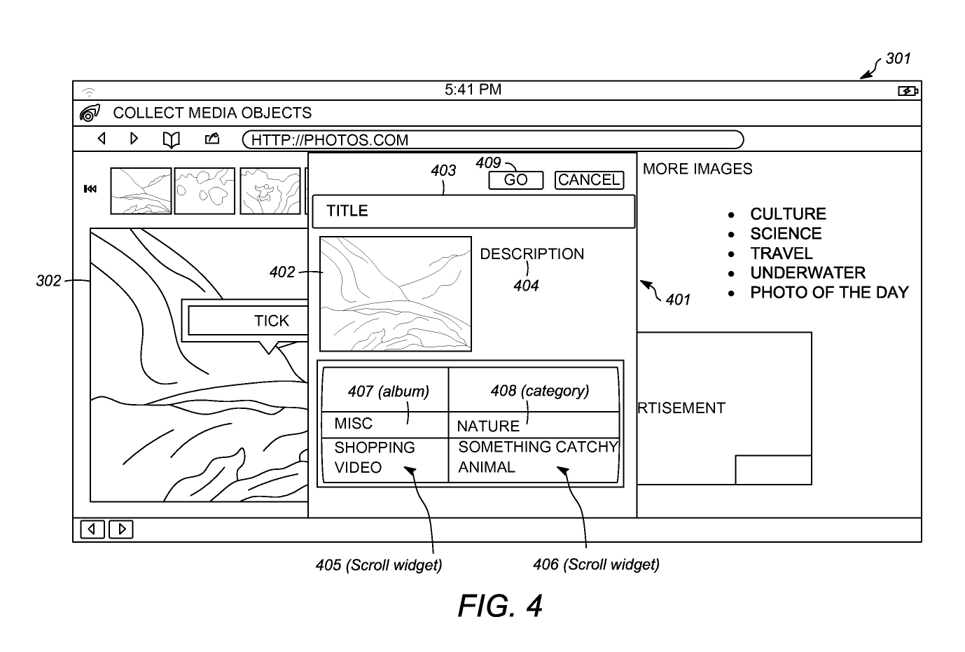

Process 100 of FIG. 1 is now discussed with reference to FIGS. 3-8, which illustrate two sets of exemplary user interfaces for collecting and/or discovering media objects. A first exemplary user interface for collecting media objects is illustrated in FIGS. 3-4. In FIG. 3, a native application operating on a tablet computer causes web page 301 to be displayed. Web page 301 includes image 302, which is a media object. The user interface shown in FIG. 3 may be referred to as a “browsing mode”. In this mode, a user can tap within the display area of a media object (e.g., image 302) of web page 301, while web page 301 is displayed, in order to initiate the process of collecting the media object. The duration of a tap may need to exceed a threshold value in order for the tap to be considered an instruction to collect a media object. When a tap of sufficient duration occurs within the display area of a media object (e.g., image 302), a confirmation button (e.g., button 303) becomes displayed overlying the media object. The media object collection process continues if the user taps the confirmation button. The media object collection process ends if the user taps elsewhere on the display.

Turning to FIG. 4, dialog window 401 is displayed in response to a tap on confirmation button 303 (FIG. 3). Dialog window 401 includes a thumbnail image 402, which is a thumbnail version of image 302. Thumbnail image 402 provides a visual confirmation of the media object (e.g., image 302) that is to be collected. Dialog window 401 also includes title field 403 for entering an optional text title for image 302, description field 404 for entering an optional text description for image 302, as well as album scroll widget 405 for selecting an album into which image 302 is to be collected. Album value 407 is treated as an album name, meaning that image 302 is to be collected into an album called “misc”, which is short for miscellaneous. A user can move the album scroll widget 405 using a swipe gesture or other suitable input to select an album name for image 302.

A user may also associate image 302, which is being collected, with a category using scroll widget 406. A category represents at least a partial description of a media object. A user can move the category scroll widget 406 using a swipe gesture or other suitable input to select a category, e.g., the category “nature,” for image 402. Using the above-described process for collecting a media object, a user may collect a media object using only three user inputs (i.e., a tap on a media object, followed by a tap on a confirmation button, e.g., “tick” button 303 (FIG. 3), followed by a tap on another confirmation button, e.g., “go” button 409).

If meta-data is available for image 302, the meta-data may be used to pre-populate title field 403, description field 404, album scroll widget 405, and/or category scroll widget 406. Meta-data may be internal and/or external. Some types of media objects include internal meta-data. For example, the JPEG image format allows for meta-data segments within a JPEG image file. Certain sources of media objects provide external meta-data information. For example, an internet image database may provide Application Programming Interface (“API”) calls for obtaining images and their corresponding meta-data information.

The association of categories to collected media objects is useful for discovering relevant and/or similar media objects because the association is performed by a human user as opposed to a machine. Assuming that the association is accurate (i.e., not a typographical error or other mistake on the part of the human user), the association of a category to a media object establishes a “ground truth” regarding the semantic meaning of the media object. That is to say, if a user associates an image with the category “art”, there should be reasonable certainty that the visual content of the image includes a work of art. Certainly, the establishing of a “ground truth” (i.e., a reasonably certain semantic meaning) to a collected media object is useful for discovering other relevant media objects, because relevant media objects are defined as those having common semantic meaning(s) with the collected media object. The use of ground truths such as category associations by machine learning mechanisms for discovering media objects is discussed further below. Note, it is possible to rely on category-to-image associations that are provided by an upstream entity (i.e., including non-human entities) as “ground truths”, provided that the associations made by the upstream entity are considered to be sufficiently trustworthy.

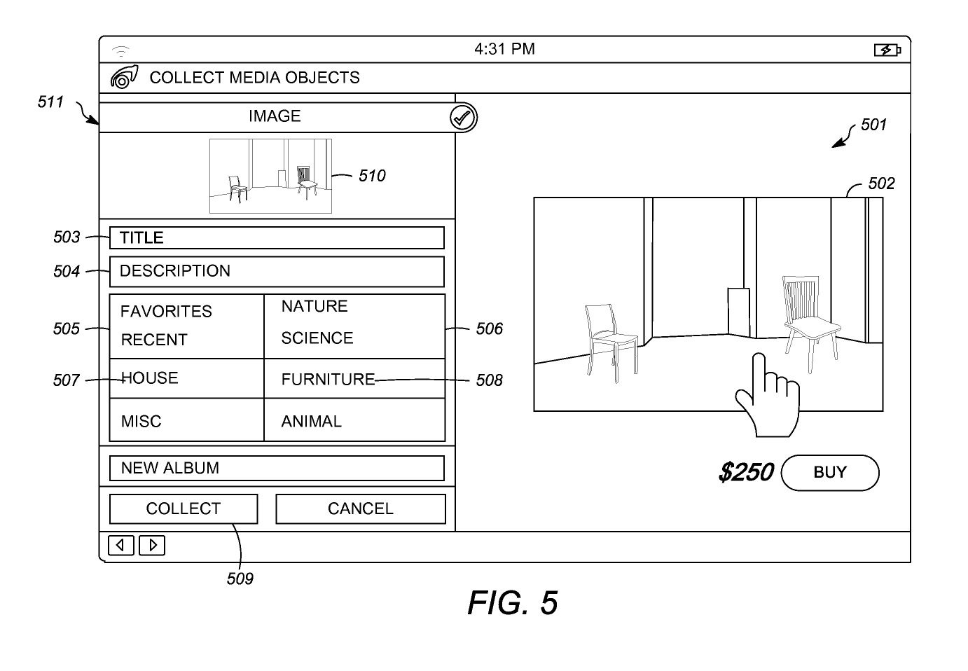

A second exemplary user interface for collecting media objects is illustrated in FIG. 5. In FIG. 5, a native application operating on a tablet computer causes web page 501 to be displayed. Web page 501 includes image 502, which contains living room furniture. The user interface shown in FIG. 5 may be referred to as a “collection mode”. In “collection mode”, pane 511 is displayed on screen alongside information that is being browsed (e.g., web page 501). A user can tap within the display area of a media object to collect the media object. For example, a user can tap within the display area of image 502 to initiate the process of collecting image 502. The user may provide an optional text title for image 502 via title field 503. The user may also provide an optional text description for image 502 via description field 504. The user may also identify the album into which image 502 is to be collected using album scroll widget 505. The user may also select a category with which image 502 is to be associated using category scroll widget 506. Pane 511 can show thumbnail image 510 of image 502. Image 502 can be collected into an album called “house”, as indicated by album value 507. Image 502 may also be associated with a category of “furniture”, as indicated by category value 508. Using the above-described process for collecting a media object, a user may collect a media object using only two user inputs (i.e., a tap on a media object, followed by a tap on a confirmation button, e.g., “collect” button 509)

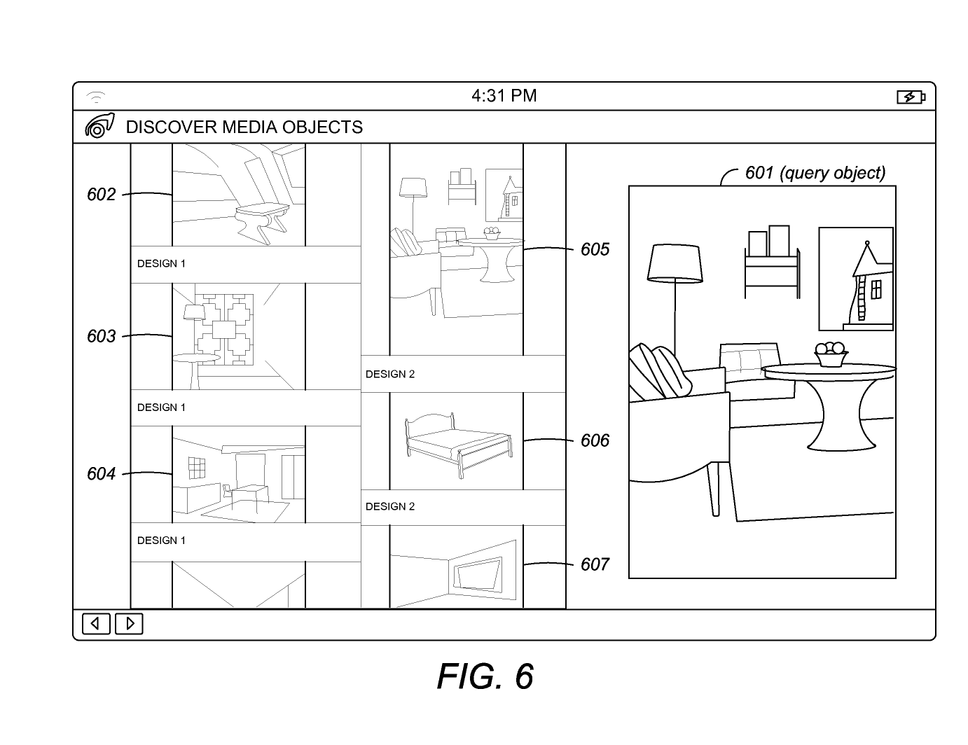

FIG. 6 illustrates an exemplary user interface for discovering other media objects. In FIG. 6, a native application operating on a tablet computer displays exemplary media object 601, which has been collected previously by a user. By way of machine learning mechanisms, the native application also discovers and displays media objects 602-607, which the machine learning mechanisms consider to be relevant to and/or similar to media object 601. Media object 601 is referred to as a query media object, because it is used to query, i.e., to search for other media objects. Media objects 602-607 can be collected by the user. In this way, the native application suggests a number of media objects (e.g., 602-607) that may be interesting to a user based on the user's past collection of media objects or other suitable criteria.

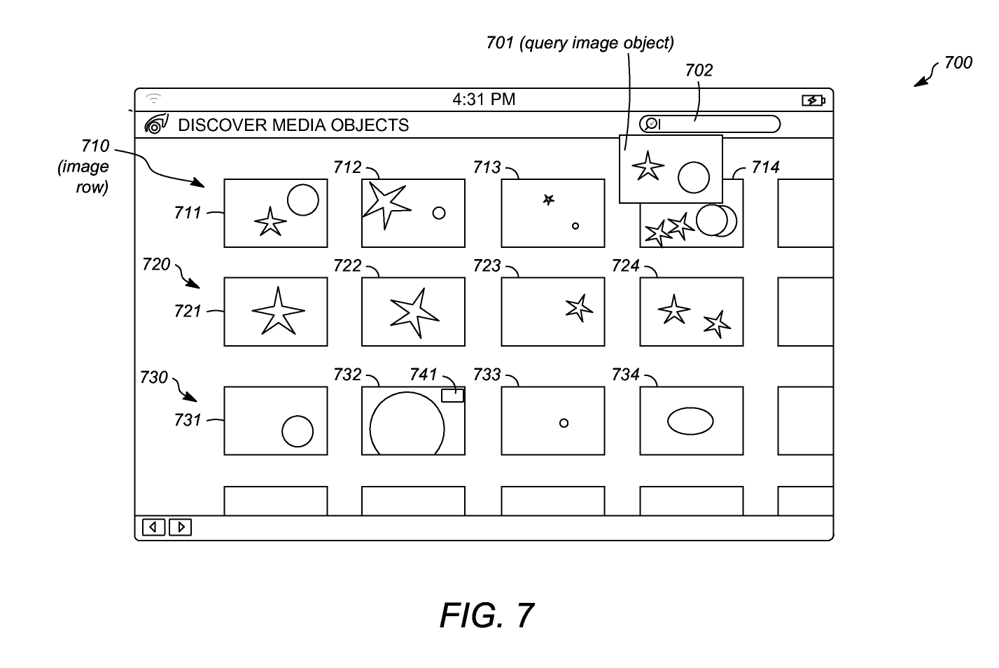

FIG. 7 illustrates another exemplary user interface for discovering other media objects. In FIG. 7, tablet computer 700 allows a user to drag a media object (i.e., image 701) into search box 702 in order to initiate a search for relevant and/or similar media objects. By way of machine learning mechanisms, the native application discovers and displays images 711-714, 721-724, and 731-734, which the machine learning mechanisms consider to be relevant to and/or similar to image 701. Images 711-714, 721-724, and 731-734 can also be collected by the user.

Notably, images 711-714, 721-724, and 731-734 are organized in the on-screen display according to their degrees of relevance to and/or similarity to image 701. As shown, the contents of image 701 include a star and a circle. Images 711-714, which also include stars and circles, are similar to image 701 and are arranged along row 710. Further, images 711-714 are arranged from left to right according to the (decreasing) probability that a particular image is identical to image 701 (as determined by the machine learning mechanisms). Row 720 consists of images 721-724, which include stars but not circles and are thus somewhat similar to image 701. Row 730 consists of images 731-734, which include circles but not stars and are thus somewhat similar to image 701. Further, image rows 710-730 are arranged from top to bottom according to the (decreasing) relevance and/or similarity to image 701. The on-screen organization of media objects may resemble a matrix. In this way, media objects that are relevant to and/or similar to a query media object are presented to the user in an organized manner.

As discussed above, media objects can be collected from various sources including remote networked resources, local computing devices, and the like. It would be helpful to provide the user with an indicator that represents the source of a collected media object. For example, image 732 consists of marking 741 that indicates image 732 was originally collected from a web page. One of skill in the art would appreciate that other markings may be used to identify particular sources of media objects. For example, another marking can be used to indicate that a media object was originally collected from the memory of a camera-equipped local computing device.

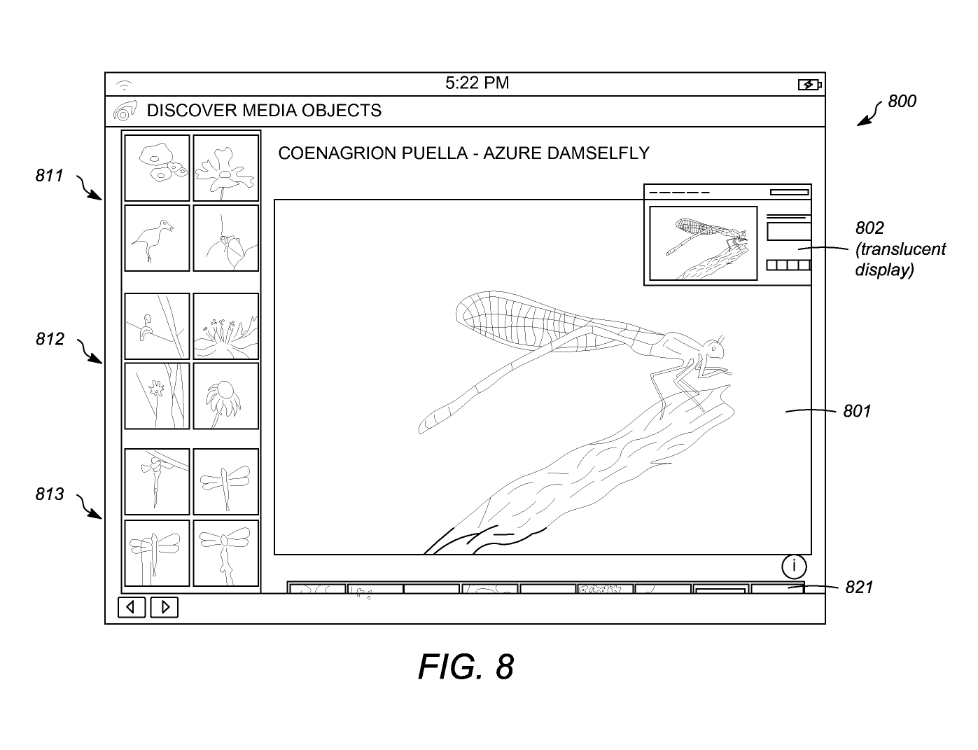

In addition, when a user selects a media object that was originally collected from a web page, the media object can be displayed along with a thumbnail image of the source of the media object. The thumbnail image can be translucent. As shown in FIG. 8, image 801 is a media object that has been collected previously by a user. Translucent thumbnail image 802 is overlaid onto the display of image 801. Translucent thumbnail image 802 includes an image of the web page from which image 801 was collected. A user may touch translucent display 802 to be redirected to the web page from which image 801 was collected. Image groups 811-813 each includes media objects (e.g., images) that are relevant and/or similar to image 802.

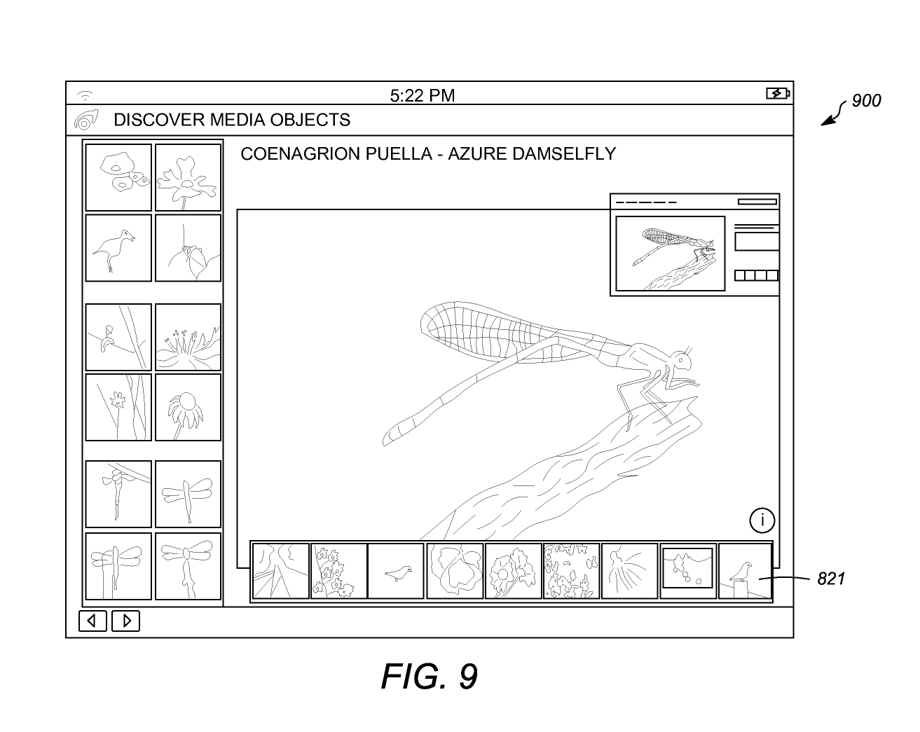

Other user interface elements can be used to display relevant and/or similar media objects to a user. As shown in FIG. 8, view 800 includes a horizontally scrollable display region 821 that can be used to display thumbnail versions of additional media objects to a user. Display region 821 can include media objects that are relevant and/or similar to image 802, within the meaning of the terms “relevant” and “similar” as discussed above. In addition, display region 821 can include media objects that are more generally related to image 802, such as other media objects that have been collected from the same source, that reside in the same album, and the like. In FIG. 8, display region 821 is shown in its partially hidden mode. In FIG. 9, display region 821 is shown in its fully displayed mode. Region 821 switches between the two modes in response to a swipe or other suitable input.

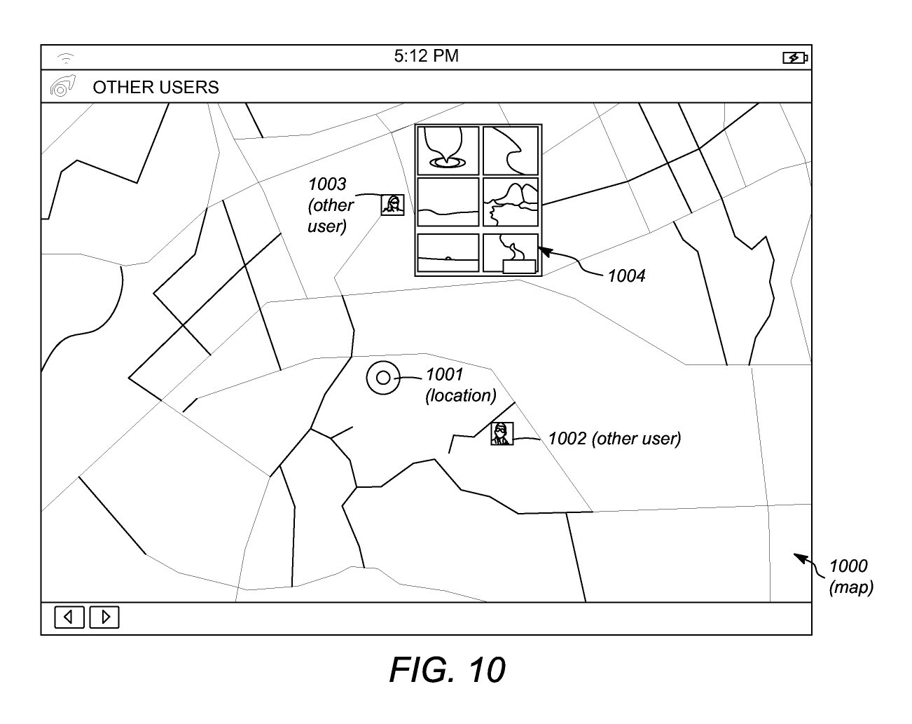

FIG. 10 illustrates user interface showing map 1000 in which a social graph with ad hoc nodes is used by a user to discover other media objects. As shown, a user located at position 1001 is notified of recent activity by other users who are located adjacent to position 1001. For example, icons 1002 and 1003 represent other nearby users who have collected media objects recently. A user may touch an icon to view the media objects that were collected by the corresponding user. For example, in response to a touch on icon 1003, window 1004 is shown with thumbnail versions of the media objects that have been collected by user 1003.

### 4. Ubiquitous Browsing

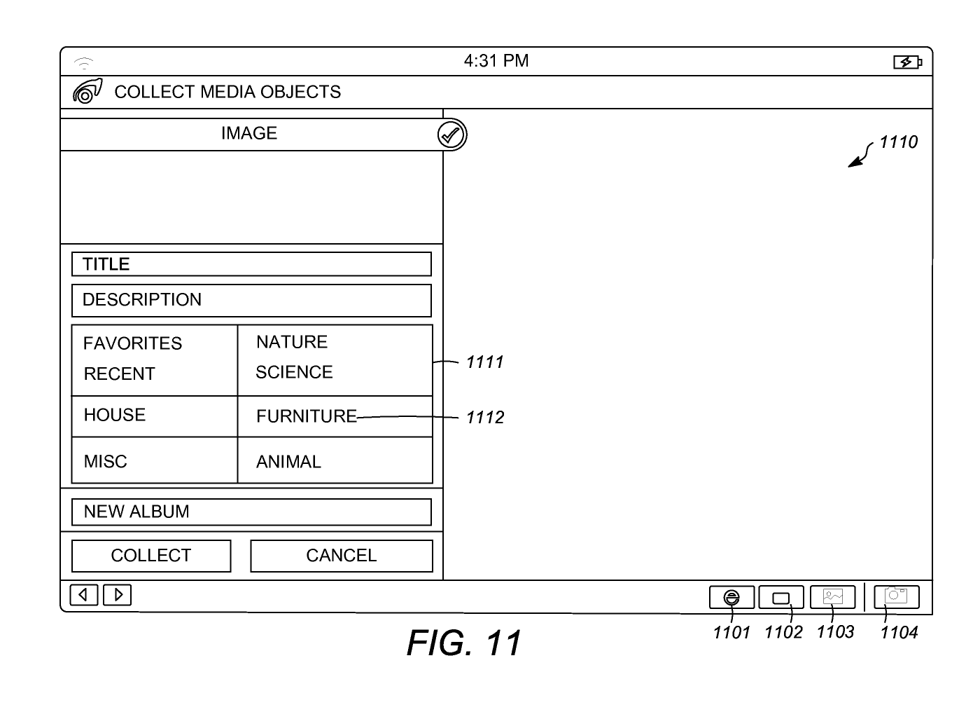

The user interface provides ubiquitous browsing capabilities, meaning that information from different sources of content may be presented via the same native application. In this way, a user does not need to transition between different applications in order to collect media objects from different sources of media objects (e.g., different web sites). FIG. 11 illustrates buttons 1101-1104 for switching between different sources of media objects for display in display area 1110 of the present exemplary user interface.

In response to a tap on button 1101, the native application displays web content in display area 1110. In this way, a user may navigate to a web page and collect media objects from the web page while still in the native application. Optionally, the received web content can be filtered before it becomes displayed in display area 1110. The web pages of internet content providers often contain media objects that are not relevant to a user. These types of media objects include advertisements, navigational elements, and the like. The native application can remove these types of media objects from a web page based on meta-data tags within the web page before the web page is displayed in display area 1110.

In response to a tap on button 1102, the native application connects to a social networking website, such as FACEBOOK, via an application programming interface (“API”) that is provided by the social networking website. In this way, the native application obtains media objects directly from the social networking website for on-screen display. A user may thus collect media objects from the social networking website via the native application.

In response to a tap on button 1103, the native application connects to an internet image database, such as FLICKR, via an API. In this way, the native application obtains media objects directly from the image database for on-screen display. A user may thus collect media objects from the internet image database. In response to a tap on button 1104, the native application obtains media objects from the memory modules of the local computing device on which the native application operates, such as an internal camera memory of a tablet computer. In this way, the native application obtains media objects that have been previously captured by the local computing device for display. A user may thus collect (and share) media objects from the local computing device.

The obtaining of media objects via APIs is different from navigation, by a user, to a web page. For one, the use of APIs allows the native application to control the display layout of media objects that are obtained. In contrast, the use of web pages to display media objects shifts the control over the display layout to the host of the web page (e.g., a social networking website). For another, the use of APIs allows the native application to retrieve only media objects that are relevant to a user, because advertisements and navigational elements, which are not relevant to a user, are typically not transmitted via API calls.

The above-described APIs may also allow the native application to obtain category information along with media objects. For example, by way of an API call, the native application may learn that a media object has been categorized as an image of “furniture” by the image database to which the image belongs. The native application may display this category information along the displayed media object. For example, category scroll widget 1111 may default to furniture category 1112 based on information transmitted via an API call from an image database. The category values, e.g., “furniture”, “art”, etc., of category scroll widget 1111 may be changed by the user.

### 5. Machine Learning Mechanisms

Machine learning mechanisms are useful for discovering media objects that are relevant to and/or similar to a query media object. The native application and/or the media object collection server can employ various machine learning mechanisms to perform the above-described processes for discovering media objects. Machine learning mechanisms that may be employed include unsupervised and supervised machine learning mechanisms. Examples of machine learning mechanisms are provided below.

### Exemplary Mechanism 1: Unsupervised Machine Learning

When an unsupervised machine learning mechanism is used, the technical representations of a set of media objects are used to train the unsupervised machine learning mechanism. In some embodiments, the machine learning mechanism utilizes a Dual-wing Harmonium Model (“DHM”), which is a special case of the Multi-wing Harmonium Model (“MHM”). The two models are discussed in E. Xing, R. Yan, A. Hauptmann, “Mining Associated Text and Images with Dual-Wing Harmoniums”. Portions relevant to DHM and MHM for identifying relevant images are hereby incorporated by reference. Technical representations of media objects can be obtained using SIFT, GIST, color histogram, Locality-constrained Linear Coding (“LLC”), and/or bags-of-words techniques. The technical representation of a media object is also referred to as a latent variable for the media object.

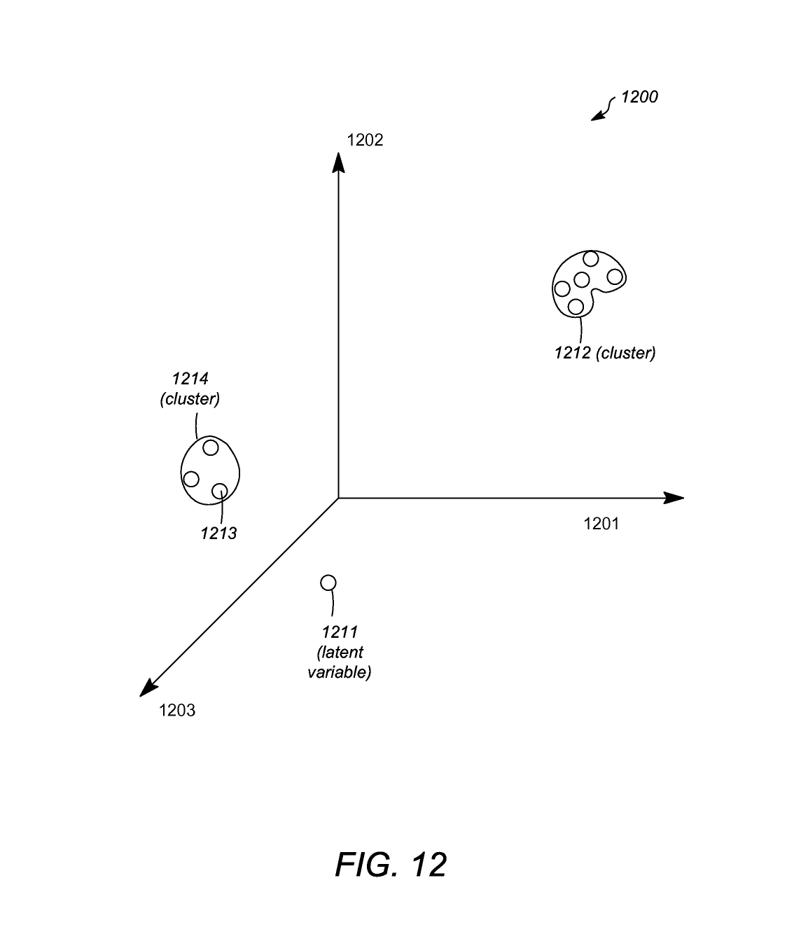

During the training phrase, the unsupervised machine learning mechanism models the inter-relatedness between media objects (as represented by their latent variables) in a semantic space 1200. For purposes of discussion, FIG. 12 illustrates an exemplary three-dimensional Cartesian semantic space. Axes 1201-1203 each represents an internal semantic meaning that has been identified by the machine training algorithm from a set of training data. Latent variables that represent a particular media object in the training data set are represented by a dot in the semantic space, e.g., dot 1211. The distance between two dots in FIG. 12 corresponds to inter-relatedness (e.g., relevance) between two media objects. Thus, it is possible to discover media objects that are relevant to a particular media object (e.g., a query media object) by applying a distance function to identify other sets of latent variables that are adjacent to a given set of latent variables. For example, the distance between dots 1211 and 1213 in semantic space 1200 can be used as a measurement of the relevance between the two corresponding media objects.

In addition, as shown in FIG. 12, multiple latent variables can form clusters. For example, cluster 1212 includes latent variables that represent media objects that are relevant to each other. In similar fashion, cluster 1214 represents media objects that are relevant to each other. The distance between the centroid of two clusters can be used to provide a measure of the relevance of the two groups of media objects. Thus, it is also possible to discover groups of media objects that are relevant to a particular media object (e.g., a query media object) by applying a distance function to identify clusters of latent variables that are adjacent to the latent variable of the query media object. For example, the media objects represented by clusters 1212 and 1214 are relevant to the media object represented by dot 1211.

Turning back to FIG. 7 with simultaneous reference to FIG. 12, rows 710, 720, and 730 may each represent a cluster of media objects within the semantic space illustrated in FIG. 12. Consider, for example, the situation in which query image 701 is represented by dot 1211. Row 710 may contain media objects that are represented by cluster 1214, which is adjacent to dot 1211, in the semantic space. Row 720 may contain media objects that are represented by cluster 1212, which is farther from, but still adjacent to dot 1211 in the semantic space. The sequence of media objects that is displayed within a particular row may be ordered according to the distance between each individual media object and the query media object. Similarly, turning to FIG. 8 with simultaneous reference to FIG. 12, image 801 may be represented by dot 1211, region 811 may contain media objects that are represented by cluster 1214, and region 812 may contain media objects that are represented by cluster 1212.

For sake of simplicity, FIG. 12 illustrates a three-dimensional Cartesian semantic space. One of ordinary skill in the art would appreciate that machine learning mechanisms can account for more than three intrinsic semantic meanings, i.e., machine learning mechanisms can extend to n-dimensional semantic spaces where n>3.

### Exemplary Mechanism 2: Supervised Machine Learning

When a supervised machine learning mechanism is used, “ground truths” of media objects may be used in conjunction with the technical representations of media objects to train the supervised machine learning mechanism. As discussed above, the term “ground truth” refers to the association of category information with media objects by a human user. Further, technical representations of media objects can be obtained using SIFT, GIST, color histogram, LLC coding, and/or bags-of-words techniques.

It has been found that a large-scale K-way classification of media objects using a supervised learning process can be turned into an L-bit code construction problem. A supervised learning process can identify a coding matrix that corresponds to the K number of classifications, as well as predictor functions for the K number of classifications. During run time, the predictor functions and a decoding scheme are used in conjunction to determine the classification of a query media object.

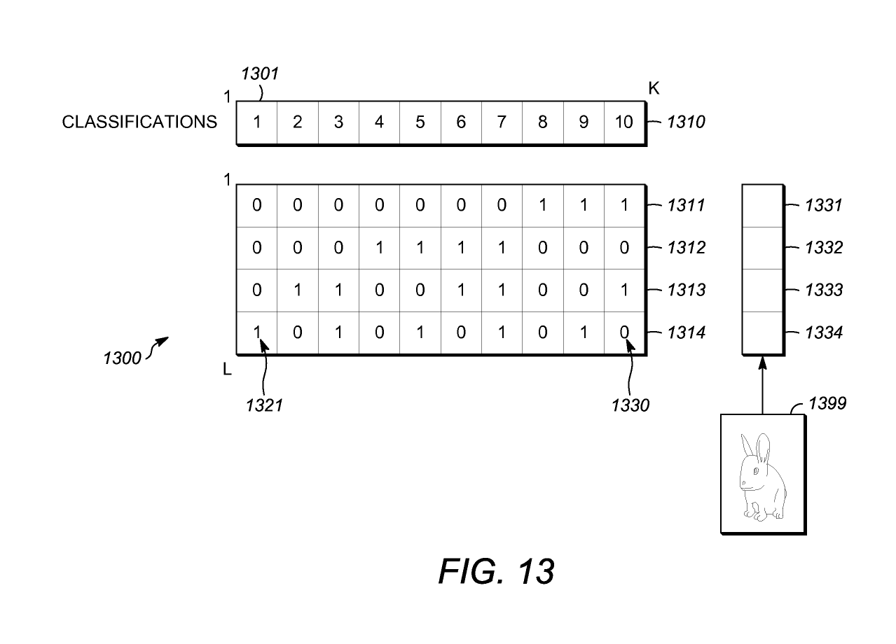

FIG. 13 illustrates an exemplary coding matrix of an L-bit code construction problem. As shown, the columns of coding matrix 1300 each correspond to a classification (e.g., a category) of media objects. Coding matrix 1300 has 10 columns, and therefore represents a 10-way classification problem. Classification 1301 corresponds to, for example, the “furniture” category of media objects. During the learning phase, a supervised machine learning mechanism uses the latent variables and the ground truths that are associated with a set of training data to identify a 4-bit code word for each of the 10 classifications. The 4-bit code words are used to construct coding matrix 1300. As shown, 4-bit code word 1321 corresponds to classification 1301. The supervised machine learning mechanism also determines a bit predictor function that can be used, during run time, to predict bits 1331-1334 for a particular query media object such as image 1399. At run time, after bits 1331-1334 are predicted using the bit predictor function, bits 1331-1334 are reconstructed into a 4-bit code word, and a lookup of the reconstructed code word is made against coding matrix 1300. For example, if bits 1331-1334 are predicted to be “1 0 1 0” based on query image 1399, then the reconstructed code word “1010” is used to identify query image 1399 as belonging to column 1330 of coding matrix 1300, meaning that query image 1399 is of classification 1310.

The term “bit predictor” is used here to denote the binary classifier associated with a column of the coding matrix. A class hierarchy is used to provide a measure of separability for each binary partition problem. Specifically, if some classes are often confused but are given different codes in the l-th column of the coding matrix, the bit predictor h₁ may not be easily learnable, and the overall multi-way classification performance will hence be poor. However, a binary partition is more likely to be well solved if the intra-partition similarity is large while the inter-partition similarity is small. Further, the introduction of ignored classes in the output coding matrix, i.e., Bε{−1, 0, +1}^{K×L} instead of Bε{−1, +1}^{K×L} is important for scaling to large scale multi-way classification.

The optimal output coding matrix B=[β₁, . . . , β_{L}] with each column B₁ε [symbol] ^{K} is learned via the following optimization problem:

$$\begin{matrix}{max}_{B} {F}_{b} ( B ) - {λ}_{r} {F}_{r} ( B ) - {λ}_{c} {\sum }_{l = 1}^{L} {‖ {β}_{l} ‖}_{2}^{2} & ( EQ . 1 ) \\ s . t . B ∈ {\{ - 1 , 0 , + 1 \}}^{K \times L} & ( EQ . 2 ) \\ {\sum }_{k = 1}^{K} I \{ {B}_{kl} = 1 \} \geq 1 , {\sum }_{k = 1}^{K} {I}_{\{ {B}_{kl} = - 1 \}} \geq 1 , ∀ l = 1 , … , L & ( EQ . 3 ) \\ {\sum }_{l = 1}^{L} {I}_{\{ {B}_{kl} \neq 0 \}} \geq 1 , ∀ k = 1 , … , K & ( EQ . 4 )\end{matrix}$$

where I is the indicator function. F_{b}(B) measures the separability of each binary partition problem associated with columns of B, and reflects the expected accuracy of bit predictors. Moreover, Fᵣ(B) measures codeword correlation, and minimizing Fᵣ(B) ensures the strong error-correcting ability of the resulting coding matrix. The l₂ regularization on each column of B controls the complexity of each bit prediction problem. λr and λc are regularization parameters. The constraints of EQ. 2 ensure that each column of the coding matrix defines a binary partition problem, with the freedom of introducing ignored classes, such that a bit predictor with high accuracy is learnable. The constraints in EQ. 3 ensure that each bit prediction problem has at least one positive class and one negative class. The constraints in EQ. 4 ensure that each class in the original K-way classification appears in at least one bit prediction problem, such that the class can effectively be decoded.

One issue in designing the coding matrix is to ensure that the resulting bit prediction problems could be effectively solved. To address this issue, an intra-partition similarity and an inter-partition similarity are calculated using semantic relatedness matrix S for each binary partition problem. A semantic relatedness matrix S, which measures similarity between classes, is computed based on the hierarchical structure among classes. Following A. Budanitsky and G. Hirst, “Evaluating wordnet-based measures of lexical semantic relatedness”, semantic affinity Aᵢⱼ between class i and class j is defined as the number of nodes shared by their two parent branches, divided by the length of the longest of the two branches, as follows:

Aᵢⱼ=intersect(path(i),path(j))/max(length(path(j))) (EQ. 5)

where path(i) is the path from root node to node i and intersect (p₁, p₂) counts nodes shared by two paths p₁ and p₂.

S=exp(−K(E−A)) (EQ. 6)

where K is a constant controlling the decay factor, and Eε [symbol] ^{K×K} is an all-one matrix.

In each binary partition problem, both positive partition and negative partition are composed of data points from multiple classes in the original problem. To encourage better separation, those classes composing the positive partition can be similar to each other. The similar argument goes for those classes composing the negative partition, but they can be different from the former set of classes which composes the positive partition. Specifically, for the l-th binary partition problem defined by βₗ, its separability could be computed as follows:

$$\begin{matrix}\begin{matrix}{F}_{b} ( {β}_{l} ) = {\sum }_{k = 1}^{K} {\sum }_{{k}^{′} = 1}^{K} ( {I}_{\{ {B}_{kl} {B}_{{k}^{′}} > 0 \}} {S}_{{kk}^{′}} - {I}_{\{ {B}_{kl} {B}_{{k}^{′}} < 0 \}} {S}_{{kk}^{′}} ) \\ = {\sum }_{k = 1}^{K} {\sum }_{{k}^{′} = 1}^{K} {B}_{kl} {B}_{{k}^{′} l} {S}_{{kk}^{′}} \\ = {e}_{K}^{T} [ {β}_{l} {β}_{l}^{T} \_S ] {e}_{K}\end{matrix} & ( EQ . 7 ) \\ where \\ {BB}^{T} = {\sum }_{l}^{ } {β}_{l} {β}_{l}^{T} , \\ and & ( EQ . 8 ) \\ {e}^{T} ( A Θ B ) e = tr ( AB ) & ( EQ . 9 )\end{matrix}$$

To decode the class label using bit predictors h(x)=[hₗ(x), . . . , h_{L}(x)], the distance between h(x) and each row in B is computed as discussed in E. Allwein, R. Schapire, and Y. Singer, “Reducing multiclass to binary: a unifying approach for margin classifiers.” Based on the distances, the class label corresponding to the codeword that is closest to h(x) is selected as the learned label for x. To increase the tolerance of errors occurred in bit predictions, the coding matrix is designed so that the rows in B are as different from each other as possible. This is accomplished by maximizing the distance between rows in B. Put another way, the inner products of the corresponding vectors are minimized. Thus, the row correlation of B could be computed as follows:

$$\begin{matrix}{F}_{r} ( B ) = {\sum }_{k = 1}^{K} {\sum }_{{k}^{′} = 1}^{K} {r}_{k}^{T} {r}_{{k}^{′}} \\ = {e}_{K}^{T} ( {BB}^{T} ) {e}_{K}\end{matrix} \qquad ( EQ . 10 )$$

where r₁^{T}, . . . , r_{K}^{T} are row vectors of coding matrix B, and e_{K}ε [symbol] ^{K} is the all-one vector.

Simply optimizing the above defined objective could possibly result in trivial solutions, where some columns in B could contain only +1 or only −1. Moreover, certain rows in B might be entirely 0, resulting in corresponding classes that are not involved in any bit prediction problem. The constraints of EQS. 3 and 4 are introduced to avoid such trivial solutions for the coding matrix. Moreover, these constraints can be reformulated as follows:

$$\begin{matrix}{\sum }_{k = l}^{K} ( \vert {B}_{kl} \vert + {B}_{kl} ) \geq 2 , \\ {\sum }_{k = l}^{K} ( \vert {B}_{kl} \vert - {B}_{kl} ) \geq 2 , \\ ∀ l = l , … , L & ( EQ . 11 ) \\ {\sum }_{l = 1}^{L} \vert {B}_{kl} \vert \geq 1 , \\ ∀ k = 1 , … , K & ( EQ . 12 )\end{matrix}$$

In EQ. 1, each element in B is constrained to {−1, 0, +1}. To enable efficient solution for the optimization problem, this constraint may be relaxed to Bε{−1, +1}^{K×L}, as discussed by K. Crammer and Y. Singer, “On the learnability and design of output codes for multiclass problems”. This reduces the optimization problem from integer programming to continuous optimization. To (re-) introduce ignored classes in binary learners, the l₁ norm of each column β₁ in B is minimized as discussed in D. Donoho, “Compressed sensing” and R. Tibshirani, “Regression shrinkage and selection via the lasso” in order to encourage sparsity of β₁. The resulting optimization problem for learning output coding matrix B becomes:

$$\begin{matrix}{min}_{B} - tr ( {BB}^{T} S ) + {λ}_{r} {e}_{K}^{T} {BB}^{T} {e}_{K} + {λ}_{c} {\sum }_{l = 1}^{L} {‖ {β}_{l} ‖}_{2}^{2} + {‖ β ‖}_{1} & ( EQ . 13 ) \\ s . t . - 1 \leq {B}_{kl} \leq 1 , \\ ∀ k = 1 , … , K ; \\ ∀ l = 1 , … , L & ( EQ . 14 ) \\ {\sum }_{k = l}^{K} ( \vert {B}_{kl} \vert + {B}_{kl} ) \geq 2 , \\ {\sum }_{k = l}^{K} ( \vert {B}_{kl} \vert - {B}_{kl} ) \geq 2 , \\ ∀ l = l , … , L & ( EQ . 15 ) \\ {\sum }_{l = 1}^{L} \vert {B}_{kl} \vert \geq 1 , \\ ∀ k = l , … , K & ( EQ . 16 )\end{matrix}$$

The problem of EQ. 13 raises two issues: the non-smoothness of the l₁ regularization on B, and the non-convexity of the objective and constraints. However, though non-convex, the problem of EQ. 13 has the special structure that the objective function is the difference of two convex functions. Specifically, both g(B)=tr(BB^{T}S) and f(B)=λᵣe_{K}^{T}BB^{T}e_{K}+λ_{c}Σₜ₌₁^{L}∥β₁∥₂²+λ₁∥B∥₁ are convex. Similarly, the constraints of EQS. 13 and 14 can be formulated as the difference between two convex functions. Thus, a concave-convex procedure based algorithm may be used to solve the problem of EQ. 13, where the non-convexity is handled by the constrained concave-convex procedure (“8P”), and the non-smoothness is handled using the dual proximal gradient method. The 8P is described in, e.g., A. Yuille and A. Rangarajan, “The concave-convex procedure”, and A. J. Smola, S. V. N. Vishwanathan, and T. Hofmann, “Kernel methods for missing variables.” An exemplary pseudo-code of a 8P algorithm is provided in Table 1.

TABLE 1
Learning output coding matrix via 8P

```
Initialize B⁰
repeat
    Find B^{t} as the solution to EQ. 17
    Set t=t+1 and get the new EQ. 17
until stopping criterion satisfied
```

Given an initial point B⁰, the 8P computes B^{t+1} from B^{t} by replacing g(B) with its first-order Taylor expansion B^{t}, i.e., g(B^{t})+<∇g(B^{t}),B−B^{t}>. Similarly, the |Bₖₗ| term appearing in the constraints can be replaced with its first-order Taylor expansion at B^{t}, i.e., sign (Bₖₗ^{t})Bₖₗ. The resulting optimization problem becomes as follows:

$$\begin{matrix}{min}_{B} = - 2 tr ( {SB}^{t} {B}^{T} ) + {λ}_{r} {e}_{K}^{T} {BB}^{T} {e}_{K} + {λ}_{c} {\sum }_{l = 1}^{L} {‖ {β}_{l} ‖}_{2}^{2} + {λ}_{l} {‖ / B ‖}_{1} & ( EQ . 17 ) \\ s . t . - 1 \leq {B}_{kl} \leq 1 , \\ ∀ k = 1 , … , K ; \\ ∀ l = 1 , … , L & ( EQ . 18 ) \\ 2 + {\sum }_{k = 1}^{K} [ - 1 - sign ( {B}_{kl}^{t} ) ] {B}_{kl} \leq 0 , \\ 2 + {\sum }_{k = l}^{K} [ 1 - sign ( {B}_{kl}^{t} ) ] {B}_{kl} \leq 0 , \\ ∀ l = 1 , … , L & ( EQ . 19 ) \\ 1 - {\sum }_{l = 1}^{L} sign ( {B}_{kl}^{t} ) {B}_{kl} \leq 0 , \\ ∀ l = 1 , … , K & ( EQ . 20 )\end{matrix}$$

Although the objective function in EQ. 17 (hereafter denoted as F(B)) is convex, F(B) is a non-smooth function of B due to the l₁ regularization imposed on B. Existing algorithms for solving non-smooth convex optimization problems include smoothing techniques where the non-smooth term is approximated by a smooth function, and a sub-gradient method. However, the use of smoothing techniques results in a loss of the sparsity inducing property of the l₁ regularization. Further, sub-gradient methods produce slow convergence and require the difficult step of selecting a step size. In similar vein, existing algorithms for solving un-constrained non-smooth convex optimization problems, such as those discussed in R. Jenatton, J. Mairal, G. Obozinski, and F. Bach, “Proximal methods for hierarchical sparse coding” and M. Schmidt, N. Le Roux, and F. Bach, “Convergence rates of inexact proximal-gradient methods for convex optimization,” are also unsuitable because of the constraints imposed on EQ. 17 due to its fast convergence and low complexity.

It has been discovered that the optimization problem of EQ. 17 can be solved in two steps. First, the dual problem to EQ. 17 is obtained. Second, the proximal gradient method is applied onto the dual problem. This process is feasible because the constraints in the dual problem are much easier for projection as compared to the constraints of EQ. 17. In this way, the optimization problem of EQ. 17 can be reformulated as:

Define β=vec(B)ε [symbol] ^{KL} as the vector obtained by stacking columns of B. (EQ. 21)

thus,

$${min}_{β} {F}_{s} ( β ) + λ {‖ β ‖}_{1} , \\ s . t . A β \leq b \qquad ( EQ . 22 )$$

$$where \\ {F}_{s} ( β ) = - 2 tr ( {SB}^{t} {B}^{T} ) + {λ}_{r} {e}_{K}^{T} {BB}^{T} {e}_{K} + {λ}_{c} {\sum }_{l = 1}^{L} {‖ {β}_{l} ‖}_{2}^{2} , \qquad ( EQ . 23 )$$

Aε [symbol] ^{(2KL+2L+K)×KL}, and (EQ. 24)

bε [symbol] ^{(2KL+2L+K)} (EQ. 25)

EQS. 23-25 are obtained by organizing the constraints in EQ. 17 according to β. Due to the difficulty of projection onto constraints Aβ≦b, existing proximal gradient method cannot be applied here. To solve this problem, Fₛ(β) and ∥β∥₁ are split into two parts by introducing an additional variable z, such that:

$${min}_{β , z} {F}_{s} ( β ) + {λ}_{1} {‖ z ‖}_{1} , \\ s . t . A β \leq b , z - β = 0 \qquad ( EQ . 26 )$$

The Lagrange for the problem of EQ. 26 is:

$$\begin{matrix}g ( γ , μ ) = {inf}_{β , z} \{ {F}_{s} ( β ) + {λ}_{1} {‖ z ‖}_{1} + {γ}^{T} ( A β - b ) + {μ}^{T} ( z - β ) \} \\ = {inf}_{β} \{ {F}_{s} ( β ) + {( {A}^{T} γ - μ )}^{T} β \} + {inf}_{z} \{ {λ}_{1} {‖ z ‖}_{1} + {μ}^{T} z \} - {γ}^{T} b \\ = - {sup}_{β} \{ - {F}_{s} ( β ) - {( {A}^{T} γ - μ )}^{T} β \} + \\ {inf}_{z} \{ {λ}_{1} {‖ z ‖}_{1} + {μ}^{T} z \} - {γ}^{T} b \\ = - {F}_{s}^{*} ( {( {A}^{T} γ - μ )}^{T} β ) + {inf}_{z} \{ {λ}_{1} {‖ z ‖}_{1} + {μ}^{T} z \} - {γ}^{T} b\end{matrix} \qquad ( EQ . 27 )$$

where Fₛ* is the conjugate function of Fₛ.

More, since the dual norm of ∥•∥₁ is ∥•∥_{∞}:

$${inf}_{z} \{ {λ}_{1} {‖ z ‖}_{1} + {μ}^{T} z \} = \{ \begin{matrix}0 & ‖ μ ‖ ∞ \leq {λ}_{1} \\ - ∞ & otherwise\end{matrix} \qquad ( EQ . 28 )$$

Therefore, the dual problem for EQ. 22 is:

$${min}_{γ , μ} h ( γ , μ ) + {F}_{s}^{*} ( - ( {A}^{T} γ - μ ) ) + {γ}^{T} b , \\ s . t . γ \geq 0 , \\ ‖ μ ‖ ∞ \leq {λ}_{1} \qquad ( EQ . 29 )$$

In order to utilize projected gradient method to solve the problem of EQ. 29, the gradient of the objective function h(γ, μ) with respect to γ and μ can be computed as follows:

$$\frac{\partial h ( γ , μ )}{\partial γ} = - A ∇ {F}_{s}^{*} ( - ( {A}^{T} γ - μ ) ) + b , \\ \frac{\partial h ( γ , μ )}{\partial γ} = ∇ {F}_{s}^{*} ( - ( {A}^{T} γ - μ ) ) \qquad ( EQ . 30 )$$

where ∇Fₛ*(−(A^{T}γ−μ))=arg min_{β}{Fₛ(β)+(A^{T}γ−μ)^{T}β}, as discussed by S. Boyd and L. Vandenberghe, “Convex Optimization”.

Moreover, Fₛ(β) can be reformulated as:

$${F}_{s} ( β ) = {\sum }_{l = 1}^{L} \{ - 2 {( {SB}^{t} )}_{l}^{T} {β}_{1} + {λ}_{r} {β}_{l}^{T} {e}_{K} {e}_{K}^{T} {β}_{l} + {λ}_{c} {β}_{l}^{T} {β}_{l} \} \qquad ( EQ . 31 )$$

where (SB^{t})ₗ denotes the l-th column of matrix SB^{t}.

Therefore, EQ. 31 can be calculated as EQ. 32:

\hat{β}=∇F*ₛ(−(A^{T}γ−μ)) (EQ. 32)

\hat{β}=[\hat{β}₁^{T} . . . \hat{β}_{L}^{T}]^{T} (EQ. 33)

where \hat{β}ₗ=½(λᵣe_{K}e_{K}^{T}βₗ+λ_{c}I)⁻¹[2(SB^{t})ₗ−(A^{T}λ−μ)ₗ], and (EQ. 34)

(A^{T}λ−μ)ₗ is the l-th column of the matrix formulated by resizing (A^{T}λ−μ) into a K×L matrix. Table 2 illustrates pseudo code for a projected gradient algorithm for solving the problem of EQ. 17. In Table 2, P represents projection onto the corresponding constraints.

TABLE 2
Dual proximal gradient method for solving EQ. 17

```
Choose step size t > 0, choose initial γ and μ
repeat
    Compute \hat{β} using EQ. 34
    γ = P_{γ≧0} (γ − t(b − A\hat{β})) ; μ = P_{||μ||}_{_{∞}}_{≦λ}_{₁} (μ − t\hat{β})
until convergence
```

In this way, a coding matrix (e.g., coding matrix 1300 in FIG. 13) and bit predictors can be computed.

### Exemplary Mechanism 3: Near-Duplication

Media objects that are similar to one another because they represent supersets and/or subsets of one another can be discovered using mechanisms referred to as “super-duplication” and “sub-duplication”, respectively. The “super-duplication” and “sub-duplication” mechanisms are referred to together as a “near-dupe” mechanism for discovering media objects. Because the near-dupe mechanism depends on similarities between media objects as opposed to relatedness, the near-dupe mechanism is especially effective for discovering media objects that contain similar images of works of art, books, posters, and the like.

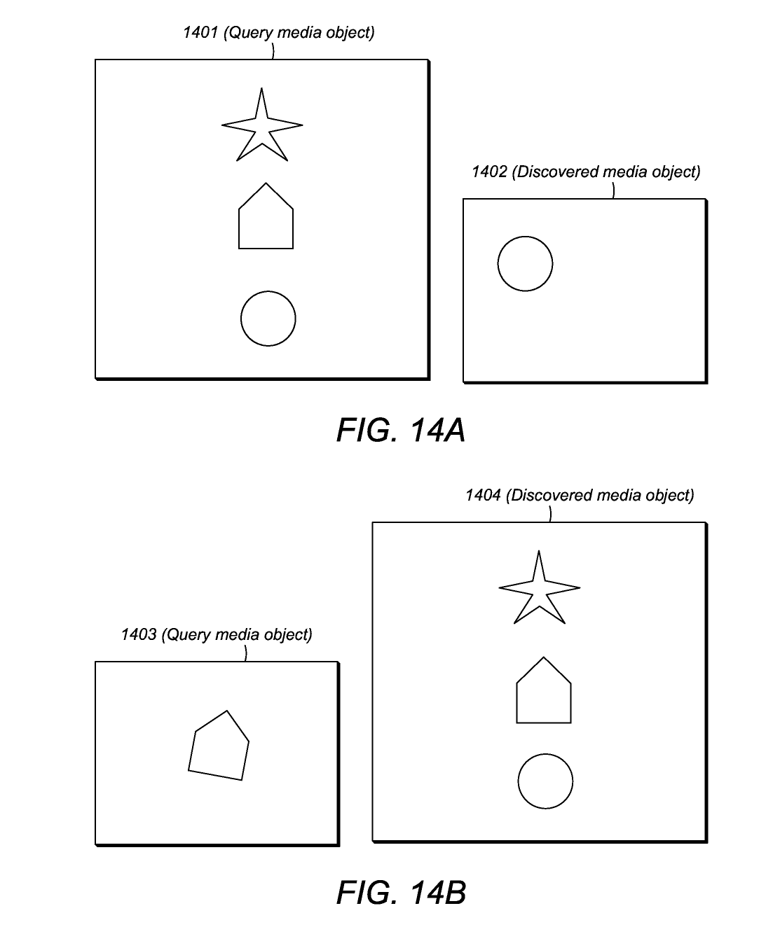

FIG. 14A illustrates media object 1401, which is a superset of media object 1402. A super-duplication mechanism may discover media object 1402 using media object 1401 as a query, by searching through media objects that appear within media object 1401. FIG. 14B illustrates media object 1403, which is a subset of media object 1404. A sub-duplication mechanism may discover media object 1404 using media object 1403 as a query, by searching through media objects that contain portions of media object 1403.

Under the near-duplication mechanism, a set of SIFT features is extracted from a training data set of media objects. Each SIFT key point is described by an n-dimensional vector. In some embodiments, n=128. A dictionary is created by performing hierarchy k-means clustering on P SIFT key points to identify Q clusters. Each cluster center is deemed as a visual word and the collection of Q clusters constitutes the dictionary. In some embodiments, P=23 million and Q=2048. During run time, a set of SIFT features is extracted from a query media object. The SIFT key points are compared against the dictionary, and the visual words that are the closest to the SIFT key points are used to create a bag of words (“BOW”) representation for the media object. The BOW representation is searched against a database of BOW representations of other media objects, and matches are shown as results.

The near-duplication mechanism can be extended to provide discovery of media objects that are related to one another. For example, the near-duplication mechanism, as described above, can be used to determine that a query image is in fact a subset of a famous painting (e.g., Mona Lisa). This knowledge can be used to retrieve other related media objects. For example, related media objects may include other facsimiles of the same famous painting (i.e., Mona Lisa). Related media objects may also include other works by the same artist (i.e., other paintings by Leonardo da Vinci).

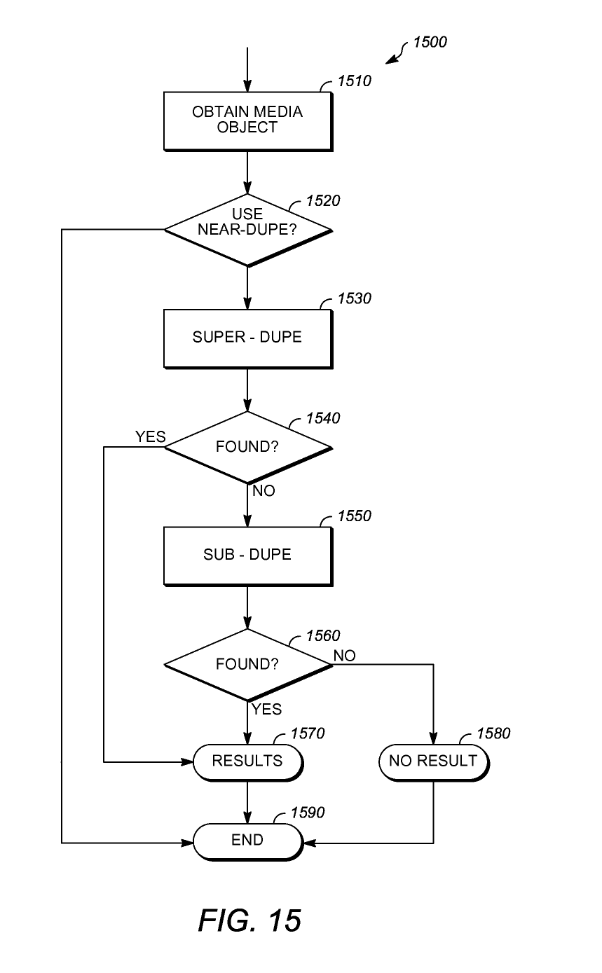

FIG. 15 illustrates exemplary process 1500 for carrying out the near-duplication mechanism. At block 1510, query media object is obtained, along with category information regarding the query media object. The category information may be a ground truth that has been provided by a user. At block 1520, the category information of the query media object is compared to a list of known categories for which the near-duplication mechanism produces superior results. For example, the list of known categories may include artwork, books, works of entertainment (e.g., CD, DVD, so forth). Processing proceeds to block 1590 if the category information is not found in the list of known categories. Processing proceeds to block 1530 if the category information is found in the list of known categories. At block 1530, the above-described super-duplication mechanism is performed by comparing the query media object against a set of media objects. At block 1540, the results of block 1530 are reviewed to determine if similar media objects have been discovered by block 1530. Processing proceeds to block 1570 if similar results were discovered. Processing proceeds to block 1550 if similar results were not discovered. At block 1550, the above-described sub-duplication mechanism is performed by comparing the query media object against a set of media objects. At block 1560, the results of block 1550 are reviewed to determine if similar media objects have been discovered by block 1550. Processing proceeds to block 1570 if similar results were discovered. Processing proceeds to block 1580 if similar results were not discovered. At block 1570, similar results may be provided to a display function so that the discovered media objects may be displayed. At block 1580, a failure condition may be provided to a downstream function so that another machine learning mechanism may be used to discover media objects. Processing ends at block 1590.

### Exemplary Mechanism 4: Text

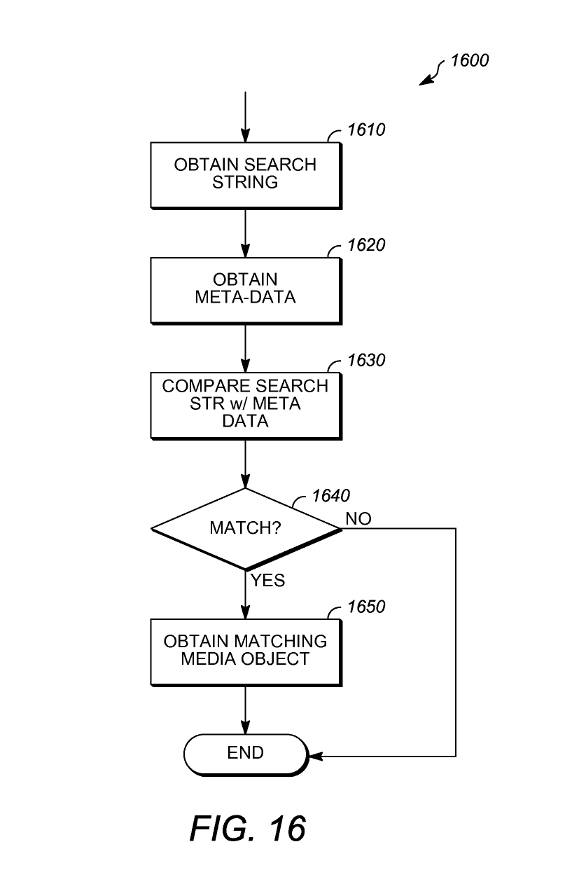

Text searches of media objects may be performed in conjunction with, or as an alternative to, the above-described mechanisms for discovering relevant and/or similar media objects. FIG. 16 illustrates exemplary process 1600 for carrying out text searches for media objects. At block 1610, a text string is obtained. At block 1620, meta-data regarding media objects is obtained. The meta-data may be internal or external. Some types of media objects include internal meta-data. For example, the JPEG image format allows for meta-data segments within a JPEG image file. Certain sources of media objects provide meta-data information. For example, an internet image database may provide Application Programming Interface (“API”) calls for obtaining images and their corresponding meta-data information. At block 1630, the text string is compared against meta-data. If a match (or a partial match) is found, the media object that corresponds to the (partially) matching meta-data is obtained for display at block 1650. If no partial match is found, processing ends.

Machine learning mechanisms are not mutually exclusive, meaning that more than one machine learning mechanism can be used to perform the above-described processes. Indeed, certain machine learning mechanisms are more adept at discovering specific categories of media objects than other machine learning mechanisms. For example, a near-duplication mechanism (discussed below) is especially adept at discovering media objects that contain artwork. As another example, a structure sparse output coding mechanism (discussed below) is especially adept at handling large-scale data sets of media objects that span a large number of classifications (e.g., large internet image databases).

Further, machine learning mechanisms can be augmented with other modeling mechanisms to improve the discovering of relevant and/or similar media objects. In the special case of media objects that involve images of book covers and/or compact disc (CD) covers, a combination of machine learning mechanisms, meta-data information, and the Latent Dirichlet Allocation (“LDA”) topic modeling mechanism is used to produce superior results.

As is generally known, a given book may have multiple editions. A user who is interested in the given book may be interested in other editions of the book. The near-duplication mechanism can be used to discover other books that are visually similar to the given book, such as other editions of the same book. Further, the user may be interested in other books that are written by the author of the given book. Meta-data information regarding the author of the given book can be extracted and be used to discover other books by the same author. Further, the user may be interested in other books of similar content (e.g., books regarding the same topic). A topic model may be used to identify other books of similar content.

For instance, the LDA topic model may be used to model the contents of a large collection of books. From the collection of books, the LDA topic model mines a set of topics, and each book in the book collection is represented by a topic vector. For each topic, a select number of “top” books in the book collection are assigned to the topic. When a query book is presented, its distribution over topics is inferred using the LDA topic model. A representative number of books in each probable topic (as determined by the LDA topic model) are displayed to the user. In this way, a user who has identified a particular book of interest can be provided with a display of other editions or versions of the same book, other books by the same author, and other books of similar topics based on the content of the particular book. These results can be displayed visually in a matrix layout that is similar to the UI shown in FIG. 7.

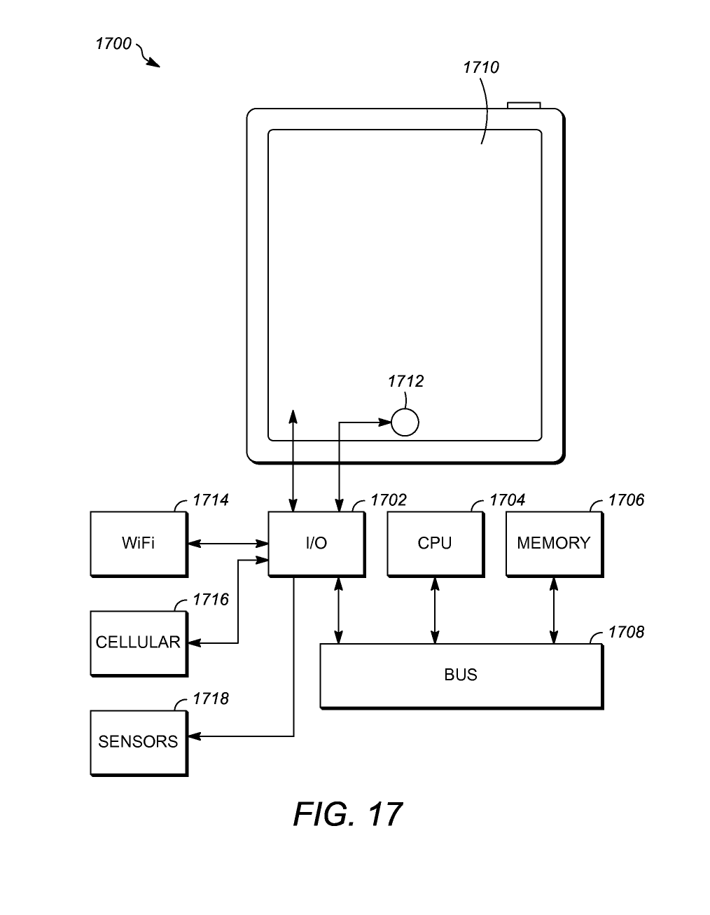

The above-described processes and algorithms may be implemented in exemplary computing system 1700. In the present exemplary embodiment, computing system 1700 may be a cellular phone and/or a tablet computer. In some embodiments, computing system 1700 is a desktop computer and/or a laptop computer. As shown in FIG. 17, computing system 1700 comprises a motherboard with bus 1708 that connects I/O section 1702, one or more central processing units (CPU) 1704, and a memory section 1706 together. Memory section 1706 may contain computer executable instructions and/or data for carrying out the above-described processes and algorithms. The I/O section 1702 may be connected to display 1710, input device 1712, which may be a touch-sensitive surface, one or more buttons, a keyboard, a mouse, or the like. I/O section 1702 may also be connected to Wi-Fi unit 1714, cellular antenna 1716, and/or sensors 1718. Sensors 1718 may include a GPS sensor, a light sensor, a gyroscope, an accelerometer, or a combination thereof.

At least some values based on the results of the above-described processes can be saved into memory such as memory 1706 for subsequent use. Memory 1706 may be a computer-readable medium that stores (e.g., tangibly embodies) one or more computer programs for performing any one of the above-described processes by means of a computer. The computer program may be written, for example, in a general-purpose programming language (e.g., C including Objective C, Java, JavaScript including JSON, and/or HTML) or some specialized, application-specific language.

Although only certain exemplary embodiments have been described in detail above, those skilled in the art will readily appreciate that many modifications are possible in the exemplary embodiments without materially departing from the novel teachings and advantages of this disclosure. For example, aspects of embodiments disclosed above can be combined in other combinations to form additional embodiments. Accordingly, all such modifications are intended to be included within the scope of this technology.

What is claimed is:

1. A computer-enabled method for identifying computer media objects, the method comprising:
displaying, on a screen of a mobile computing device, a first media object, wherein the displaying is caused by an application, wherein the application is native to operating platform of the mobile computing device, wherein the first media object is obtainable from a first source;
identifying a first classification and a second classification of the first media object based on content of the first media object, wherein the first classification and the second classification each represents at least a partial description of the first media object;
obtaining, from a second source, a plurality of media objects based on the first classification or the second classification; and
displaying, on the screen, at least a subset of the obtained plurality of media objects, wherein the displayed subset of the plurality of media objects is visually organized based on at least one of the first classification or the second classification.

2. The method of claim 1, wherein the obtaining comprises:
executing an unsupervised machine learning mechanism based on the first media object.

3. The method of claim 2, wherein:
the unsupervised machine learning mechanism is based on the dual-wing harmonium model.

4. The method of claim 1, wherein the obtaining comprises:
executing a supervised machine learning mechanism based on the first media object.

5. The method of claim 4, wherein:
the supervised machine learning mechanism is based on a code construction problem.

6. The method of claim 1, further comprising:
receiving, from a user, an instruction to select the displayed first media object, wherein the instruction is a tap or click on a portion of the displayed first media object;

7. The method of claim 1, wherein:
at least one of the first classification or the second classification provides semantic meaning to the first media object.

8. The method of claim 1, wherein:
the first media object is part of a web page that is being displayed by the native application, and
wherein the native application further causes the screen to switch from a display of the web page to a display of objects from an internet repository of media objects, in response to another user instruction.

9. The method of claim 1, wherein:
the first media object is part of a web page that is being displayed by the native application, and
wherein the obtaining of media object identifier does not include displaying another web page to the user.

10. The method of claim 1, wherein:
the first media object is an image, a video clip, or an audio clip.

11. The method of claim 1, wherein the first source is a user.

12. The method of claim 1, wherein the second source is the internet.

13. The method of claim 1, wherein:
the displayed subset of the plurality of media content objects is visually grouped into a first group and a second group,
wherein the first group comprises a display of a subset of the plurality of media objects that are related to the first media object based on the first classification, and
wherein the second group comprises a display of another subset of the plurality of media objects that are related to the first media object based on the second classification.

14. The method of claim 1, wherein:
the displayed subset of the plurality of media content objects is visually organized as a matrix, and
wherein each row of the matrix represents a particular classification, and
each row of the matrix comprises a display of a subset of the plurality of media objects that are related to the first media content, based on the particular classification.

15. A computer-enabled method for discovering social media users, the method comprising:
obtaining, from a first user, a first media object identifier, wherein the first media object identifier identifies a first media object obtainable from the internet;
identifying a first physical location, wherein the first physical location is the location of the first user at the time when first media object identifier was obtained;
sending the media object identifier and the first physical location to a server;
identifying a second user based on the first physical location, wherein:
the second user is associated with a second media object identifier that was obtained and sent to the server, and
the second user was located within a particular distance of the first physical location at the time when the second media object was obtained; and
displaying, to the first user, information about the second user, and a second media object identified by the second media object identifier.

16. The method of claim 15, wherein the identifying of the second user is further based on the time when the first media object identifier was obtained and the time when the second media object identifier was obtained.

17. A computer-enabled method for collecting computer media objects, the method comprising:
displaying, on a screen of a mobile computing device, a media object obtainable from the internet, wherein the displaying is caused by an application native to an operating platform of the mobile computing device;
receiving, from a user, an instruction to select the media object, wherein the instruction comprises a click or a tap on the displayed first media object; and
instructing a server to obtain the media object.

18. The method of claim 17, wherein:
the media object is part of a web page that is being displayed by the native application, and
wherein the server is instructed to obtain the media object without requiring the display of another web page.

19. A computer-enabled method for searching for computer media objects, the method comprising:
obtaining, from a user, a media object identifier, wherein the first media object identifier identifies a query media object obtainable from the internet;
identifying a first plurality of media objects, wherein the first plurality of media objects comprises media objects that are visually similar to the query media object, and wherein the identifying comprises executing the run-time portion of a machine learning algorithm;
identifying a second plurality of media objects, wherein the second plurality of media objects comprises media objects each having a meta-data value that is similar to a meta-data value of the query media object;
identifying a third plurality of media objects, wherein the third plurality of media objects comprises media objects each having semantic content that is similar to the semantic content of the query media object; and
displaying at least a subset of the media objects of each of the first, second, and third pluralities of media objects.

20. The computer-enabled method of claim 19,
wherein the query media object represents a book,
wherein the identifying of the third plurality media objects comprises executing a Latent Dirichlet Allocation topic modeling mechanism based on a vector representation of the query media object, and
wherein the semantic content of the query media is the textual content of the book.

21. The method of claim 19, wherein the obtaining comprises:
executing an unsupervised machine learning mechanism based on the first media object.

22. The method of claim 21, wherein:
the unsupervised machine learning mechanism is based on the dual-wing harmonium model.

23. The method of claim 19, wherein the obtaining comprises:
executing a supervised machine learning mechanism based on the first media object.

24. The method of claim 23, wherein:
the supervised machine learning mechanism is based on a code construction problem.

25. A non-transitory computer-readable storage medium having computer-executable instructions for identifying computer media objects, the computer-executable instructions comprising instructions for:
displaying, on a screen of a mobile computing device, a first media object, wherein the displaying is caused by an application, wherein the application is native to an operating platform of the mobile computing device;
collecting the first media object to include a first classification and a second classification based on content of the first media object
obtaining a plurality of media objects based on the first classification or the second classification; and
displaying, on the screen, at least a subset of the plurality of media objects.

26. The computer-readable storage medium of claim 21, the computer-executable instructions further comprising instructions for:
sharing the plurality of media objects between a user of the mobile computing device and other users.

27. The computer-readable storage medium of claim 21, wherein the displayed subset of the plurality of media objects is visually organized based on at least one of the first classification or the second classification.

28. A handheld mobile device for identifying computer media objects, the device comprising:
a screen configured to display a first media object;
a touch-sensitive surface coupled to the display, the touch-sensitive surface configured to receive a user selection of the first media object; and
a processor coupled to the display and the touch-sensitive surface, the processor configured to:
identify a first classification and a second classification of the first media object based on content of the first media object, wherein the first classification and the second classification each represents at least a partial description of the first media object;
to obtain, from a second source, a plurality of media objects based on the first classification or the second classification; and
to cause the display, on the screen, of at least a subset of the plurality of media objects, wherein the displayed subset of the plurality of media objects is visually organized based on at least one of the first classification or the second classification.
